(19) United States
(12) Patent Application Publication
(10) Pub. No.: US 2023/0213009 A1
(43) Pub. Date: Jul. 6, 2023

(54) INTAKE DEVICE FOR A COMPRESSOR

(71) Applicant: TURBO SYSTEMS SWITERZLAND LTD., Baden (CH)

(72) Inventors: Heinz-Jürgen FELD, Niederwil (CH); Marcel JOHO, Auenstein (CH)

(21) Appl. No.: 18/008,943

(22) PCT Filed: May 26, 2021
(86) PCT No.: PCT/EP2021/064061

§ 371 Date: Dec. 7, 2022

(30) Foreign Application Priority Data
Jun. 16, 2020 (EP) 20180315.2

(51) Int. Cl. F02M 35/12; F02M 35/10

(52) U.S. Cl. CPC F02M 35/1288; F02M 35/1211; F02M 35/1272; F02M 35/10157; F02B 37/00

(57) ABSTRACT

The invention relates to an intake device for a compressor. The intake device comprises a support structure having a plurality of struts which are arranged in the circumferential direction about an axis of the support structure and extend in the radial direction. Furthermore, the intake device comprises a plurality of first sound-damping elements which are arranged in the radial continuation of the plurality of struts. In addition, the intake device comprises a plurality of second sound-damping elements, each of which is arranged between adjacent first sound-damping elements. The invention furthermore relates to an exhaust-gas turbocharger having the intake device according to the invention, and an internal combustion engine having an exhaust-gas turbocharger of this kind.

### TECHNICAL FIELD

The invention relates to the field of exhaust turbochargers for pressure-charged internal combustion engines. In particular, the invention relates to an intake device for a compressor of an exhaust turbocharger.

### TECHNICAL BACKGROUND

Exhaust turbochargers are nowadays used as standard for increasing the power of internal combustion engines, having a turbine in the exhaust tract of the internal combustion engine and having a compressor upstream of the internal combustion engine. Here, the exhaust gases of the internal combustion engine are expanded in the turbine. The work thus obtained is transferred by means of a shaft to the compressor, which compresses the air fed to the internal combustion engine. By using the energy of the exhaust gases to compress the air fed to the combustion process in the internal combustion engine, it is possible to optimize the combustion process and the efficiency of the internal combustion engine.

During operation of the exhaust turbocharger, sound waves of undesirably high amplitude typically occur predominantly in the compressor impeller, and these are released to the environment through the air intake duct. These sound waves are therefore usually damped by means of a sound-damping intake device, for example a filter muffler.

The prior art discloses filter mufflers which are typically used on the intake side of a compressor which compresses the combustion air and feeds it to an internal combustion engine. A compressor of this kind is driven by the exhaust turbine of an exhaust turbocharger.

The filter mufflers are usually designed in such a way that ambient air can be introduced through a filter arranged on the circumference of a filter muffler into a filter muffler interior fitted with damping elements, then flows past the damping elements and, in the process, is deflected by guide elements to the compressor impeller, from which sound waves emanate counter to the air flow. The sound damping is accomplished by dissipation at the damping elements, in that the sound energy is converted directly into heat by porous or fibrous absorption materials, from which the damping elements are substantially constructed.

It has been found that the sound-damping intake devices known from the prior art have certain disadvantages in respect of the required size of the installation space and in respect of the pressure losses which occur.

### BRIEF DESCRIPTION OF THE INVENTION

It is the object of the present invention to provide an intake device, an exhaust turbocharger and an internal combustion engine which are improved with regard to at least one of the disadvantages known from the prior art. In particular, it is an object of the present invention to provide an intake device which is as compact as possible for a compressor, for example a compressor of an exhaust turbocharger of an internal combustion engine, with which it is possible to achieve a pressure loss which is as low as possible. It is a further object of the present invention to provide an intake device which meets the acoustic requirements with regard to the lowest possible noise generation.

To achieve the abovementioned object, an intake device as claimed in independent claim 1 is provided. Further aspects, advantages and features of the present invention can be found in the dependent patent claims, the description and the accompanying figures.

According to one aspect of the invention, an intake device for a compressor is provided. The intake device comprises a support structure having a multiplicity of struts, which are arranged around an axis of the support structure in the circumferential direction and extend in the radial direction. Furthermore, the intake device comprises a multiplicity of first muffler elements, which are arranged in the radial continuation of the multiplicity of struts. In addition, the intake device comprises a multiplicity of second muffler elements, each of which is arranged between adjacent first muffler elements.

Thus, an intake device is advantageously provided which is improved over the intake devices known from the prior art. In particular, the intake device according to the invention provides an intake device which is designed in such a way that the flow through the intake device can have a largely constant speed of flow. Furthermore, it is possible with the intake device according to the invention to minimize outflow vortices and to keep sudden changes in cross section small, thus advantageously enabling pressure losses to be minimized. Moreover, an intake device is provided which enables a compact installation space and low-cost production and meets the acoustic requirements with regard to the lowest possible noise generation.

According to a second aspect of the invention, an exhaust turbocharger having an intake device according to one of the embodiments described herein is provided, wherein the support structure of the intake device according to the invention is connected to a compressor housing of the exhaust turbocharger. Thus, an improved exhaust turbocharger can advantageously be provided.

A third aspect of the invention relates to an internal combustion engine having an exhaust turbocharger according to one of the embodiments described herein. Thus, an improved internal combustion engine can advantageously be provided.

### BRIEF DESCRIPTION OF THE FIGURES

The invention will be explained below with reference to exemplary embodiments, which are illustrated in the figures and from which further advantages and modifications can be derived. Here:

FIG. 1 shows a schematic perspective sectional view of an intake device according to embodiments described herein, which is arranged on an intake side of a compressor; and

FIG. 2 shows a detail of a schematic axial sectional view of an intake device according to embodiments described herein.

### DETAILED DESCRIPTION OF THE FIGURES

The various embodiments will now be discussed in detail below, one or more examples thereof being illustrated in each figure. Each example serves for explanation and should not be interpreted as restrictive. For example, features illustrated or described as part of one embodiment may be used on or in conjunction with any other embodiment to obtain a further embodiment. It is intended that the present disclosure should include such modifications and variations.

In the following description of the drawings, the same reference numbers refer to the same or similar components. In general, only the differences with respect to the individual embodiments are described. Unless stated otherwise, the description of a part or aspect in one embodiment may also relate to a corresponding part or corresponding aspect in another embodiment.

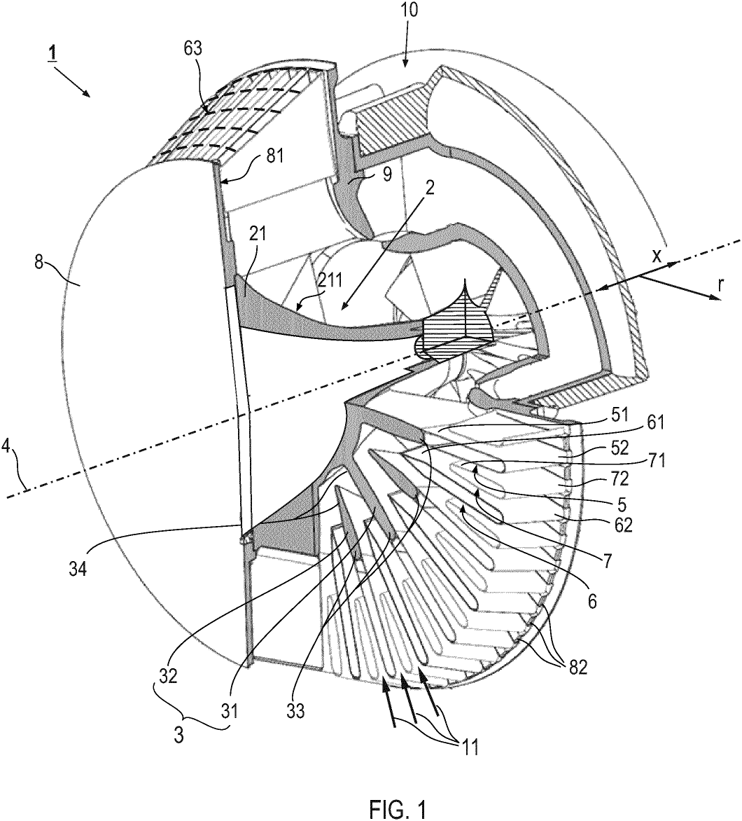

FIG. 1 shows a schematic perspective sectional view of an intake device 1 for a compressor according to embodiments described herein. The compressor housing 10 of the compressor is schematically indicated. The intake device 1 is arranged on an intake side of a compressor.

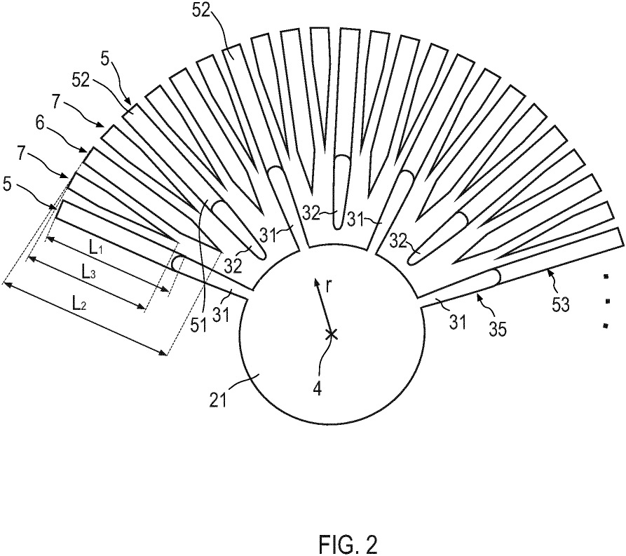

According to one embodiment, which can be combined with other embodiments described herein, the intake device 1 comprises a support structure 2 having a multiplicity of struts 3. The multiplicity of struts 3 is arranged around an axis 4 of the support structure 2 in the circumferential direction. The axis 4 of the support structure 2 extends in the axial direction x. The multiplicity of struts 3 extends in the radial direction r. Typically, the axis 4 of the support structure 2 is a central axis of the support structure 2. As illustrated by way of example in FIG. 1, the intake device 1 comprises a multiplicity of first muffler elements 5. The multiplicity of first muffler elements 5 is arranged in the radial continuation of the multiplicity of struts 3. Furthermore, the intake device 1 comprises a multiplicity of second muffler elements 6, each of which is arranged between adjacent first muffler elements 5. The first muffler elements 5 and the second muffler elements 6 are arranged radially, around the axis 4 of the support structure 2 in the circumferential direction. In other words, the first muffler elements 5 and the second muffler elements 6 can be arranged in a uniformly distributed manner in the circumferential direction, in particular around the axis 4 of the support structure 2. In particular, the first muffler elements 5 and the second muffler elements 6 can be arranged alternately in the circumferential direction. Furthermore, third muffler elements 7 can be arranged between the first muffler elements 5 and the second muffler elements 6, as described herein and illustrated by way of example in FIGS. 1 and 2.

It should be noted that the muffler elements described herein can also be referred to as guide ribs. As can be seen from FIG. 1, the number of guide ribs increases from the inside (i.e. from the axis 4) to the outside, with the result that the flow cross sections are advantageously substantially constant in the radial direction between the guide ribs.

Thus, an intake device is advantageously provided which is improved over the intake devices known from the prior art. In particular, the intake device is advantageously designed in such a way that the flow through the intake device can have a largely constant speed of flow. Furthermore, the intake device makes it possible to minimize outflow vortices and sudden changes in cross section, thereby advantageously making it possible to reduce pressure losses. In this context, it should be noted that, in principle, each element which is installed in the flow leads to pressure losses. These arise on account of various mechanisms, such as surface friction and outflow vortices. The pressure losses rise sharply with increasing speed of flow. From this point of view, the embodiments of the intake device which are described herein are improved in terms of fluid mechanics.

Moreover, an intake device is provided which enables a compact installation space and low-cost production and meets the acoustic requirements with regard to the lowest possible noise generation.

According to one embodiment, which can be combined with other embodiments described herein, radially inwardly directed ends 51 of the multiplicity of first muffler elements 5 are each in contact with radially outwardly directed ends 33 of the multiplicity of struts 3 in such a way that a continuous flow area is formed by the side faces 53 of the first muffler elements and the side faces 35 of the struts 3, as shown by way of example in FIG. 2. Thus, the struts 3 of the support structure 2 and the first muffler elements 5 form a common geometric shape, and this has a positive effect on the minimization of pressure losses, such that flow separations can be avoided.

According to one embodiment, which can be combined with other embodiments described herein, the radially inwardly directed ends 51 of the multiplicity of first muffler elements 5 can each be in positive-locking contact with the radially outwardly directed ends 33 of the multiplicity of struts 3.

According to one embodiment, which can be combined with other embodiments described herein, the intake device 1 further comprises a multiplicity of third muffler elements 7, as illustrated by way of example in FIGS. 1 and 2. The third muffler elements 7 are typically each arranged between a first muffler element 5 and a second muffler element 6. The third muffler elements 7 have a smaller radial extent than the second muffler elements 6. In particular, the third muffler elements 7 can be arranged in a uniformly distributed manner in the circumferential direction, in particular around the axis 4 of the support structure 2.

According to one embodiment, which can be combined with other embodiments described herein, the support structure 2 comprises a central conical element 21, as illustrated by way of example in FIG. 1. The multiplicity of struts 3 is typically connected to an outer circumferential surface 211 of the central conical element 21. For example, the struts 3 can be integrally connected to the outer circumferential surface 211 of the central conical element 21. In particular, the central conical element 21 and the multiplicity of struts 3 can be designed in the form of a cast part or milled part. Alternatively, the struts 3 can be connected to the central conical element 21 by means of a screwed joint or welded joint.

According to one embodiment, which can be combined with other embodiments described herein, the central conical element 21 is a hollow conical element. Typically, the outer circumferential surface 211 of the conical element 21 is of concave design, as illustrated by way of example in FIG. 1.

According to one embodiment, which can be combined with other embodiments described herein, the multiplicity of struts 3 comprises a first group of first struts 31 and a second group of second struts 32, as shown by way of example in FIGS. 1 and 2. Typically, the first struts 31 have a longer axial extent than the second struts 32. For example, the first group of first struts 31 and the second group of second struts 32 can each have half the total number of struts 3. Typically, the first struts 31 and the second struts 32 are arranged alternately in the circumferential direction.

According to one embodiment, which can be combined with other embodiments described herein, the multiplicity of struts 3 each have a radially inner end 34 with a taper, as shown by way of example in FIG. 1. In other words, the thickness of the struts 3 is reduced toward the axis 4 of the support structure 2.

As an alternative or in addition, the multiplicity of second muffler elements 6 can each have a radially inner end 61 with a taper, as is likewise shown in FIG. 1. In other words, the thickness of the muffler elements 6 is reduced toward the axis 4 of the support structure 2. Or in other words, the muffler elements 6 have a taper on the outflow side. The flow direction of the flow between the muffler elements of the intake device is illustrated by way of example by the arrows 11 in FIG. 1.

According to one embodiment, which can be combined with other embodiments described herein, the third muffler elements 7 taper radially inward, as shown by way of example in FIG. 2. In other words, the third muffler elements 7 have a taper on the outflow side.

According to one embodiment, which can be combined with other embodiments described herein, the second muffler elements 6 are each arranged at least partially between adjacent struts 3, as illustrated by way of example in FIGS. 1 and 2.

According to one embodiment, which can be combined with other embodiments described herein, the intake device 1 further comprises a front element 8 and a rear element 9, as shown by way of example in FIG. 1. The front element 8 can be a front plate. For example, the front plate can be designed in the form of a disk, in particular a circular disk, as illustrated by way of example in FIG. 1. The rear element 9 can be a rear plate, in particular a rear plate with a central opening. The rear plate can be designed in the form of a disk, in particular a circular disk, with a central opening, as illustrated in FIG. 1. The first muffler elements 5 can be mounted in such a way that they can be inserted radially between the front element 8 and the rear element 9. As an alternative or in addition, the third muffler elements 7 can be mounted in such a way that they can be inserted radially between the front element 8 and the rear element 21. The second muffler elements 6 can be mounted in an axially insertable manner. Alternatively, the second muffler elements 6 can be mounted in such a way that they can be inserted radially between the front element 8 and the rear element 21.

According to one embodiment, which can be combined with other embodiments described herein, the front element 8 has a first positioning device 81 for the first muffler elements 5 and/or the second muffler elements (6) and/or the third muffler elements 7. Furthermore, the rear element 9 can have a second positioning device 82 for the first muffler elements 5 and/or the third muffler elements 7. The first positioning device 81 is typically located opposite the second positioning device 82.

According to one embodiment, which can be combined with other embodiments described herein, radially outer ends 52 of the first muffler elements 5, radially outer ends 62 of the second muffler elements 6 and radially outer ends 72 of the third muffler elements 7 lie on a common circumferential surface 63, as illustrated by way of example in FIG. 1. A filter plate, in particular a perforated plate, for example, can be arranged on the common circumferential surface.

According to one embodiment, which can be combined with other embodiments described herein, the first muffler elements 5 have a first length L1, the second muffler elements 6 have a second length L2, and the third muffler elements 7 have a third length L3. The third length L3 is typically less than the first length L1. The first length L1 can be less than the second length. Alternatively, the second length L2 can be less than the first length L1. Mathematically speaking, one of the following inequalities can be satisfied: (1) L3<L1<L2 or (2) L3<L2<L1.

According to one embodiment, which can be combined with other embodiments described herein, the first muffler elements 5 described herein and/or the second muffler elements 6 described herein and/or the third muffler elements 7 described herein each comprise an absorption element, which typically consists of a damping material. For example, the damping material can be a foam material, a felt or a nonwoven, in particular a polyester nonwoven. The absorption element is typically at least partially surrounded by a damping and absorbing protector. In particular, the damping and absorbing protector can be a damping plate, which is designed, for example, in such a way that an interspace is formed between the side walls of a damping element. The absorption element can be introduced into this interspace.

As can be seen from the embodiments described herein, an intake device, an exhaust turbocharger and an internal combustion engine are advantageously provided which are improved over the prior art. In particular, a compact intake device for a compressor is provided with which, in comparison with the prior art, a lower pressure loss can be achieved, while the acoustic requirements with regard to the lowest possible noise generation can be met. According to the embodiments described herein, the speed of flow is advantageously kept virtually constant in each cross section in the muffling region of the intake device, leading to minimization of the flow losses. The available installation space can be optimally equipped with muffler elements, thus enabling optimum acoustic damping to be achieved. It should be mentioned at this point that the intake device described herein can also be used without muffler elements, comprising only the support structure 2 with the struts 3. This can be taken into consideration, for example, when noise generation does not play a role and no sound damping is therefore necessary.

Thus, by means of the embodiments described herein, it is possible to provide an intake device for a turbocharger which meets the requirements of low-cost production, a small overall volume, low pressure loss and optimum sound damping.

By using the intake device according to the embodiments described herein for a turbocharger of an internal combustion engine, it is thus possible to provide an improved turbocharger and hence an improved internal combustion engine.

LIST OF REFERENCE SIGNS

| | |
|---|---|
| 1 | intake device |
| 11 | flow direction of the flow between the muffler elements |
| 2 | support structure |
| 21 | central conical element of the support structure |
| 211 | outer circumferential surface of the central conical element |
| 3 | multiplicity of struts |
| 31 | first struts |
| 32 | second struts |
| 33 | radially outwardly directed ends of the multiplicity of struts |
| 34 | radially inner end of the second struts |
| 35 | side face of the multiplicity of struts |
| 4 | axis of the support structure |
| 5 | first muffler elements |
| 51 | radially inwardly directed ends of the first muffler elements |
| 52 | radially outer ends of the first muffler elements |
| 53 | side face of the first muffler elements |
| 6 | second muffler elements |
| 61 | radially inner end of the second muffler elements |
| 62 | radially outer ends of the second muffler elements |
| 63 | circumferential surface |
| 7 | third muffler elements |
| 71 | radially inner end of the third muffler elements |
| 72 | radially outer ends of the third muffler elements |
| 8 | front element |
| 81 | first positioning device |
| 82 | second positioning device |
| 9 | rear element |
| 10 | compressor housing |
| L₁ | first length of the first muffler elements |
| L₂ | second length of the second muffler elements |
| L₃ | third length of the second muffler elements |
| r | radial direction |
| x | axial direction |

1. An intake device for a compressor, comprising:
a support structure having a multiplicity of struts, which are arranged around an axis of the support structure in the circumferential direction and extend in the radial direction,
a multiplicity of first muffler elements, which are arranged in the radial continuation of the multiplicity of struts, and
a multiplicity of second muffler elements, each of which is arranged between adjacent first muffler elements, wherein radially inwardly directed ends of the multiplicity of first muffler elements are each in contact with radially outwardly directed ends of the multiplicity of struts in such a way that a continuous flow area is formed by the side faces of the first muffler elements and the side faces of the struts, and wherein the multiplicity of second muffler elements each have a radially inner end with a taper.

2. The intake device as claimed in claim 1, wherein the radially inwardly directed ends of the multiplicity of first muffler elements are each in positive-locking contact with the radially outwardly directed ends of the multiplicity of struts.

3. The intake device as claimed in claim 1, further comprising a multiplicity of third muffler elements, which are each arranged between a first muffler element and a second muffler element, wherein the third muffler elements have a smaller radial extent than the second muffler elements.

4. The intake device as claimed in claim 1, wherein the support structure comprises a central conical element, and wherein the multiplicity of struts are connected to an outer circumferential surface of the central conical element.

5. The intake device as claimed in claim 4, wherein the central conical element is a hollow conical element, and wherein the outer circumferential surface is concave.

6. The intake device as claimed in claim 1, wherein the multiplicity of struts comprises a first group of first struts and a second group of second struts, wherein the first struts have a longer axial extent than the second struts.

7. The intake device as claimed in claim 1, wherein the multiplicity of struts each have a radially inner end with a taper.

8. The intake device as claimed in claim 3, wherein the third muffler elements taper radially inwards.

9. The intake device as claimed in claim 1, wherein the second muffler elements are each arranged at least partially between adjacent struts.

10. The intake device as claimed in claim 1, further comprising a front element and a rear element, wherein at least one of the first muffler elements , the second muffler elements, and the third muffler elements can be mounted in such a way that they can be inserted radially between the front element and the rear element.

11. The intake device as claimed in claim 10, wherein the front element has a first positioning device for at least one of the first muffler elements, the second muffler elements, and the third muffler elements, and wherein the rear element has a second positioning device for at least one of the first muffler elements, the second muffler elements, and the third muffler elements, and wherein the first positioning device is located opposite the second.

12. The intake device as claimed inclaim wherein radially outer ends of the first muffler elements, radially outer ends of the second muffler elements and radially outer ends of the third muffler elements lie on a common circumferential surface.

13. The intake device as claimed claim 1, wherein the first muffler elements have a first length L1, the second muffler elements have a second length L2, and the third muffler elements have a third length L3, wherein the third length L3 is less than the first length L1, and wherein the first length L1 is less than the second length (L3<L1<L2) .

14. An exhaust turbocharger having an intake device for a compressor, the intake device comprising:
a support structure having a multiplicity of struts, which are arranged around an axis of the support structure in the circumferential direction and extend in the radial direction,
a multiplicity of first muffler elements, which are arranged in the radial continuation of the multiplicity of struts, and
a multiplicity of second muffler elements, each of which is arranged between adjacent first muffler elements, wherein radially inwardly directed ends of the multiplicity of first muffler elements are each in contact with radially outwardly directed ends of the multiplicity of struts in such a way that a continuous flow area is formed by the side faces of the first muffler elements and the side faces of the struts, and wherein the multiplicity of second muffler elements each have a radially inner end with a taper,
wherein the support structure of the intake device is connected to a compressor housing of the exhaust turbocharger.

15. An internal combustion engine having an exhaust turbocharger as claimed in claim 14.

16. The intake device as claimed in claim 1, wherein the support structure comprises a central conical element, and wherein the multiplicity of struts are integrally connected to an outer circumferential surface of the central conical element.

17. The intake device as claimed in claim 4, wherein the multiplicity of struts comprises a first group of first struts and a second group of second struts, wherein the first struts have a longer axial extent than the second struts.

18. The intake device as claimed in claim 4, wherein the multiplicity of struts each have a radially inner end with a taper.

19. The intake device as claimed in claim 4, wherein the second muffler elements are each arranged at least partially between adjacent struts.

20. The intake device as claimed in claim 1, wherein the first muffler elements have a first length L1, the second muffler elements have a second length L2, and the third muffler elements have a third length L3, wherein the third length L3 is less than the first length L1, and wherein the second length L2 is less than the first length L1 (L3<L2<L1).
